(19) United States
(12) Patent Application Publication
(10) Pub. No.: US 2013/0218884 A1
(43) Pub. Date: Aug. 22, 2013

(54) METHOD AND SYSTEM FOR PROVIDING A REVIEW FROM A CUSTOMER RELATIONSHIP MANAGEMENT SYSTEM

(71) Applicant: salesforce.com, inc., (US)

(72) Inventors: Jager McConnell, San Francisco, CA (US); Ciara Peter, San Francisco, CA (US)

(73) Assignee: salesforce.com, inc., San Francisco, CA (US)

(21) Appl. No.: 13/632,476

(22) Filed: Oct. 1, 2012

Related U.S. Application Data
(63) Continuation-in-part of application No. 13/401,514, filed on Feb. 21, 2012.

(51) Int. Cl. G06F 17/30

(52) U.S. Cl. 707/728; 707/E17.005

(57) ABSTRACT

A method for providing a review from a customer relationship management (CRM) system is disclosed. The method includes receiving a message including a request for a review relevant to a viewer from a requesting user system associated with a first user, where the message also includes information identifying a review subject and readily available information related to the viewer. Reviews related to the review subject and managed by a CRM system are identified and a relevance score is determined for each of the records based on relevance factors relating to the viewer and to data managed by the CRM system, and social media influence factors relating to social media content from a social networking entity. Recommended reviews are selected based on the relevance scores of the reviews, and information identifying the recommended reviews is included in a response message that is transmitted to the requesting user system.

### CLAIM OF PRIORITY

This application is a continuation-in-part of U.S. patent application Ser. No. 13/401,514, filed Feb. 21, 2012 (Attorney Docket No. 1200.107NPR1/681US1), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to an automated process for providing a customer review to a user system from a customer relationship management system on a cloud computing platform.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

When an enterprise sells a product or provides a service to a customer, oftentimes, the enterprise solicits and records the customer's opinion of the product or service in a review, which can be a survey, a written statement, an audio recording, an audio visual recording, or any other medium that conveys the customer's opinion of the product or service. In some cases, the enterprise can be the manufacturer or the producer of the product, or the retailer or distributor of the product or service, or both. Alternatively, the customer can provide his review to an entity that solicits and publishes reviews for a variety of products and services. For example, such an entity can be a social media website that solicits and/or encourages customers to submit reviews of products, restaurants, stores, and/or service providers for consumption by other users of the social media website and/or the general public.

Customer reviews are important to the enterprise producing and/or distributing the product and to the consumer interested in purchasing the product. The enterprise and/or the consumer can use reviews of a product to gage the popularity of the product, to identify problems with the product, and/or to compare similar products to the product. In addition, the enterprise can use positive reviews to persuade a customer to use the product or service, and the consumer can use the same reviews to select the product/service knowing that others are also satisfied with the product/service.

For any given product, numerous reviews for the product can exist, and in most cases, the reviews are not unanimously good or bad. Rather, the product/service typically has some excellent reviews, some mediocre reviews and inevitably some poor reviews. In the best of circumstances, the enterprise or the consumer can evaluate each review to determine why a particular reviewer gave an excellent review and why another reviewer gave a poor review, and based on those determinations, can decide whether those reasons are important or relevant to the customer or to the consumer. For example, when an excellent review is based on factors that are irrelevant to the consumer, and a poor review is based on factors that are important to the consumer, the consumer can discount the excellent review and rely more heavily on the poor review in making her decision. On the other hand, when an excellent review is based on factors that are relevant to a customer, the enterprise can highlight the excellent review to encourage the customer to user the product/service.

As stated above, determining which of the numerous reviews is most relevant to the customer/consumer oftentimes requires evaluating, e.g., reading, listening to, or watching, each of the reviews. When the number of reviews is in the hundreds or in the thousands, evaluating each review is difficult, if not impossible. Accordingly, in many cases, the reviews are categorized or sorted by certain generic factors, including when the review was submitted or created, whether the review was submitted by a certified reviewer (e.g., a reviewer recognized by the enterprise as a trusted reviewer), the reviewer's ranking (e.g., number of stars), and whether others found the review helpful. While sorting on these generic factors can help to identify a subset of reviews that might be relevant to a generic customer/consumer, there is no indication that those reviews will be relevant to a specific customer/consumer. Moreover, the number of reviews in the subset can still be substantial.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is an operational flow diagram illustrating a high level overview of an exemplary method for providing a review to a user system from a CRM system according to an embodiment;

FIG. 2 illustrates a representative system for providing and presenting a review to a user system from a CRM system according to an embodiment;

FIG. 3A is a block diagram representing an exemplary system for providing a review to a user system from a CRM system according to an embodiment;

FIG. 3B is a block diagram representing an exemplary review recommendation service hosted by a server for providing a review to a user system from a CRM system according to another embodiment;

FIG. 4 is a block diagram representing an exemplary system for providing a review from a CRM system according to an embodiment;

FIG. 5A illustrates an exemplary user system displaying a review list from a CRM system according to an embodiment;

FIG. 5B illustrates an exemplary user system displaying a review list from a CRM system according to another embodiment;

FIG. 5C illustrates an exemplary user system displaying a review list from a CRM system according to another embodiment;

FIG. 6 illustrates a block diagram of an example of an environment where an on-demand database service might be used; and

FIG. 7 illustrates a block diagram of an embodiment of elements of FIG. 6 and various possible interconnections between these elements.

### DETAILED DESCRIPTION

### General Overview

Systems and methods are provided for providing a review to a user system from a CRM system in a cloud computing environment. Managing customer reviews can be challenging because for any given product or service, numerous reviews for the product can exist. Deciding which review will be most useful in a given situation is difficult without actually evaluating each review and without knowing information about the person or entity accessing the review. For example, a software application can have thousands of reviews by thousands of reviewers who have interacted with the application. For a salesperson trying to sell the application to a buyer who may be affiliated with a particular enterprise, selecting and presenting one or more reviews that resonate with the buyer can be an important factor in closing the deal. Nevertheless, selecting which review(s) that would be most relevant to the buyer (referred to as the “viewer”) can be difficult without extracting detailed and/or personal information about the viewer, and without knowing the details of each review.

In many situations, while the salesperson can easily determine the viewer's name, the viewer's personal information is not readily available to the salesperson, and in the some cases, the viewer's personal information may never be available, e.g., when the viewer refuses to share personal information with the salesperson. Moreover, even when the viewer is willing to share, the salesperson might not know what particular personal information would be most helpful in selecting relevant reviews. In addition, even when the relevant personal information can be obtained, retrieving relevant reviews is difficult because the reviews are not typically categorized according to the personal information of the viewer. Rather, as stated above, the reviews are generally sorted by date created, ranking, and/or by certified reviewers. Thus, even when personal information about the viewer is available, neither the salesperson nor the viewer can retrieve reviews that are particularly relevant to the viewer.

To address this issue, a review recommendation service is configured to search for and retrieve customer reviews that are timely and personally relevant to a viewer, and to provide those recommended reviews to a user system of a user so that they can be presented in real time to the viewer. According to an embodiment, the reviews for a product or service are stored and managed by a customer relationship management (CRM) system, which typically refers to a software-based solution implemented on one or more computer devices that collect, organize and manage customer and sales information of an enterprise. Most CRM systems include features that allow an enterprise to track and record interactions, including emails, documents, jobs, faxes, and scheduling. These systems typically focus on accounts and generally include opportunity insight for tracking sales pipelines and can include added functionality for marketing and service. Other CRM systems also offer sales force automation features that streamline all phases of the sales process. For example, such CRM systems can support tracking and recording every stage in the sales process for each prospective customer, from initial contact to final disposition. In addition, CRM systems can support enterprise marketing, technical/customer support and service, event and meeting calendaring, and predictive analytics. Reviews of products and/or services provided or sold by an enterprise can be stored in the enterprise's CRM system where they can be accessed by enterprise personnel across different groups, e.g., marketing, sales, technical support, and in some cases, by customers and external business partners.

In an embodiment, the review recommendation service can be configured to receive a request for recommended reviews from a requesting user system of a user, and to receive readily available information related to the viewer and information identifying a review subject. For example, the readily available information relating to the viewer can include information identifying the viewer and information identifying an enterprise affiliated with the viewer. According to an embodiment, when the request and the information are received, the review recommendation service can be configured to identify reviews related to the requested review subject and managed by the CRM system. Once the reviews have been identified, the review recommendation service can be configured to determine a relevance score for each of the identified reviews based on one or more relevance factors relating to the viewer and/or the viewer's enterprise and to data managed by the CRM system. In addition, the relevance score is based on one or more social media influence factors relating to social media content from at least one social networking entity.

In an embodiment, the relevance score of a review can reflect the importance or relevance of the review to the viewer. Accordingly, the relevance factors can be directed to, among other things, whether the viewer knows the review's reviewer, whether the reviewer is an influential person in the industry, similarities between the viewer and the reviewer, and similarities between the viewer's enterprise and an enterprise affiliated with the reviewer. Once relevance scores have been determined for at least some of the reviews, the review recommendation service can be configured to identify one or more reviews based on their respective relevance scores, and to transmit information identifying the recommended reviews in a response message to the requesting user system.

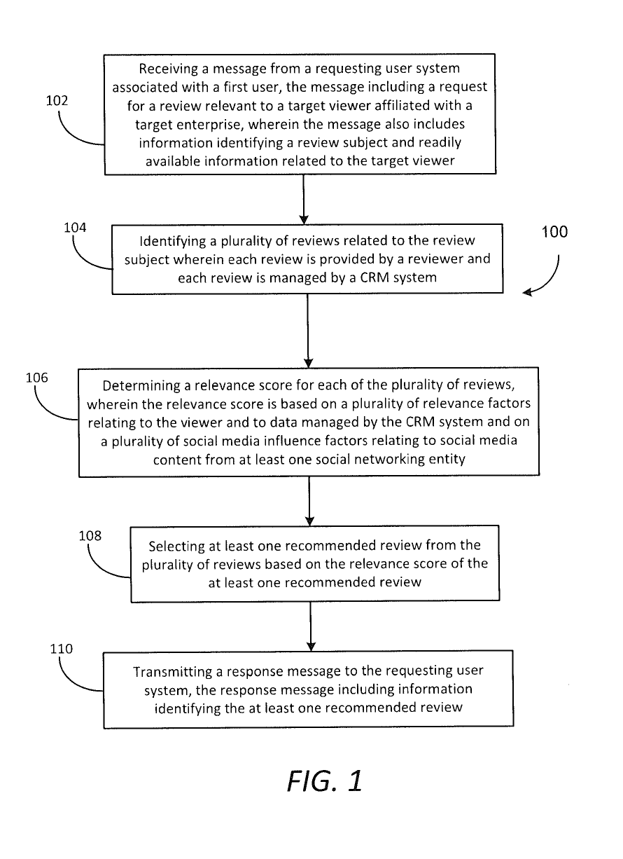

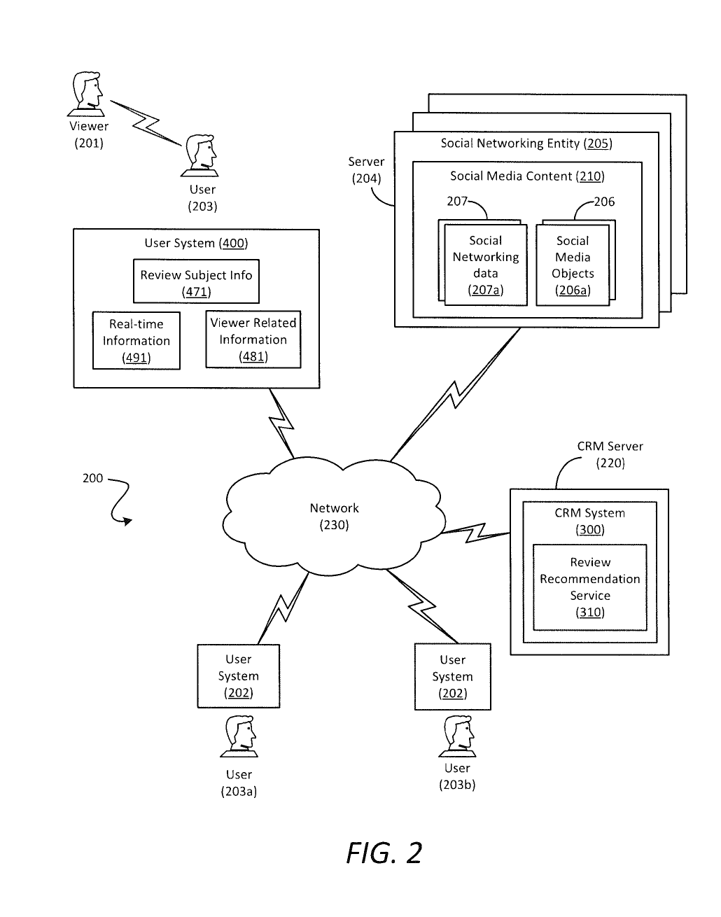

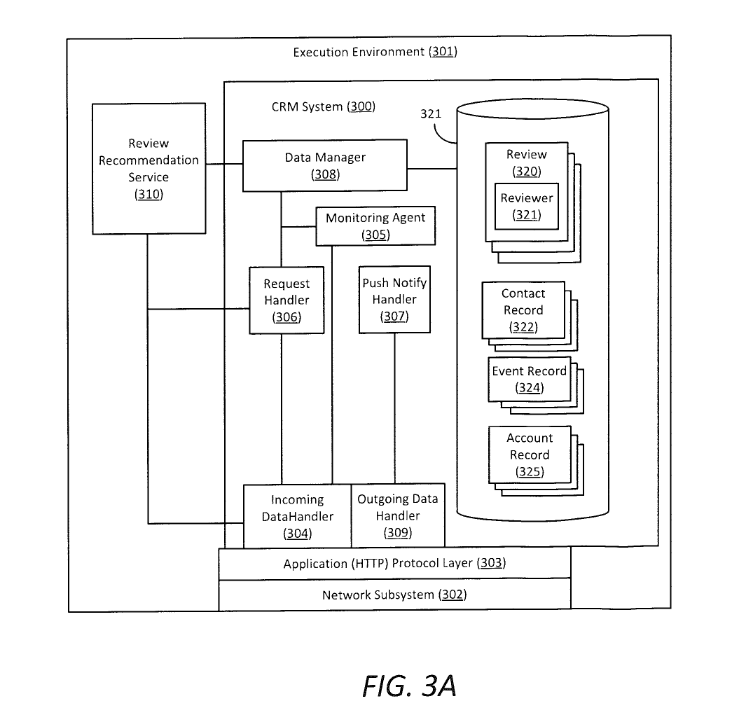

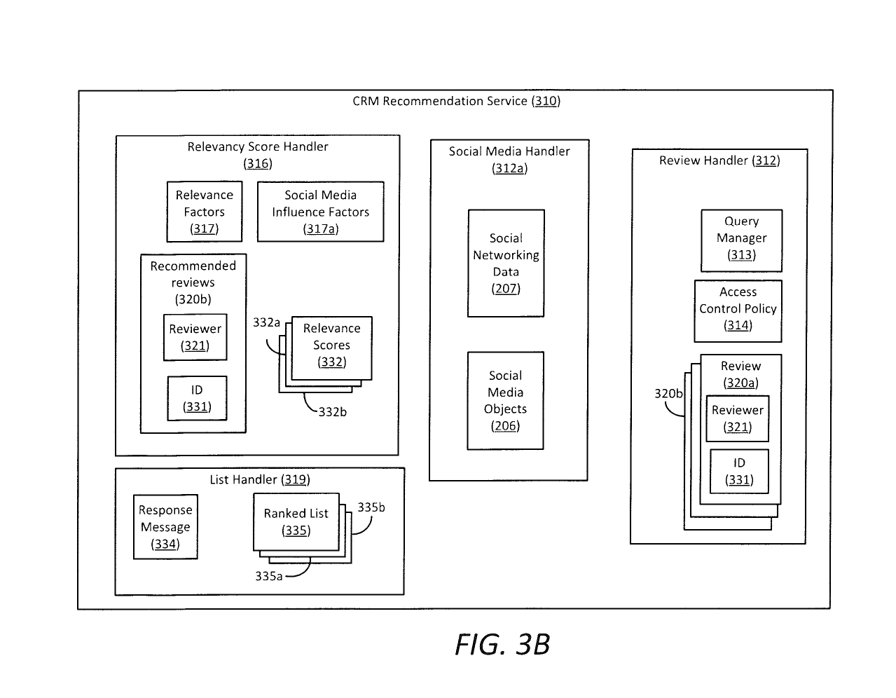

Referring now to FIG. 1, a flow diagram is presented illustrating a method 100 for providing a review to a user system from a CRM system according to an embodiment. FIG. 2 illustrates a representative system 200 for providing a review to a user system from a CRM system according to an embodiment. FIG. 3A is a block diagram illustrating an exemplary system for providing a review to a user system from a CRM system and in particular, illustrates an arrangement of components configured to implement the method 100 of FIG. I, which also can be carried out in environments other than that illustrated in FIG. 3A.

FIG. 3A illustrates components that are configured to operate within an execution environment hosted by a physical or virtual computer node and/or multiple computer nodes, as in a distributed execution environment. Exemplary computer nodes can include physical or virtual desktop computers, servers, networking devices, notebook computers, PDAs, mobile phones, digital image capture devices, and the like. For example, FIG. 2 illustrates a plurality of user system computer nodes 202, 400 and application server nodes 204, 220 communicatively coupled to one another via a network 230, such as the Internet. In an embodiment, a CRM application server 220 can be configured to provide an execution environment configured to support the operation of the components illustrated in FIG. 3A and/or their analogs. One example of such a CRM server 220 will be described later in greater detail during reference to later illustrated embodiments.

According to an embodiment, each user system node 202, 400 can represent a virtual or physical computer device through which a user, e.g., user 203, can communicate, via the network 230, with other users or contacts 203a, 203b, and with application servers, such as a social networking server 204 and the CRM server 220. In an embodiment illustrated in FIG. 3A, a CRM system 300 includes components adapted for operating in an execution environment 301. The execution environment 301, or an analog, can be provided by a node such as the application server node 220. The CRM system 300 can include an incoming 304 and an outgoing 309 data handler component for receiving and transmitting information from and to the plurality of user system nodes 202, 400 and/or the application server nodes 204 via the network 230.

In an embodiment, the CRM system 300 includes a data store 321 for storing a plurality of data objects including reviews 320, contact records 322 of users affiliated with the enterprise, event records 324 relating to enterprise events, and account records 325. As used herein, a CRM record can include, but is not limited to, a tuple corresponding to a person or user, an enterprise, a file, a case, a folder, an opportunity, a product, an account, an event, an interaction, and/or any data object. The CRM system 300 can include a data manager component 308 that can be configured to insert, delete, and/or update the data objects stored in the data store 321. In addition, the CRM system 300 can include a monitoring agent 305 that is configured to monitor activities or interactions related to the data objects. For example, the monitoring agent 305 can be configured to detect a user's post via a public or private social networking service 205, and/or a user's email client on the user's enterprise desktop computer, and to monitor updates to the contact records 322, event records 324, and/or any other data objects stored in the data store 321.

In an embodiment, the data store 321 can be a database system located in a cloud computing environment, and may be implemented as a multi-tenant database system. As used herein, the term multi-tenant database system refers to those systems in which various elements of hardware and software of the database system may be shared by one or more customers or enterprises. For example, a given application server 220 may simultaneously process requests for a great number of customers or enterprises, and a given database table may store rows for multiple customers or enterprises.

According to an embodiment, the execution environment 301, or an analog, provided by the CRM server node 220 can also include a review recommendation service 310. Alternatively, as is shown in FIG. 2, the review recommendation service 310 can be a component integrated with the CRM system 300. FIG. 3B is a block diagram illustrating an exemplary review recommendation service 310 according to an embodiment, which can be configured to receive information from the user system nodes 202, 400 and/or from the social networking entities 205, and to retrieve and provide information to the user system nodes 202, 400 via the network 230.

The network 230 can be a local area network (LAN) or a wide area network (WAN), such as the Internet. Each user system node 202, 400 may include an application that allows network communication between the user system 202, 400 and the CRM service 310 hosted by the application server 220. Such an application can be, in an embodiment, a web portal (not shown) provided by a network browser (e.g., Chrome, Internet Explorer, Safari, etc.) or the like that is capable of sending and receiving information to and from the application servers 204, 220.

FIG. 1, as stated above, illustrates a method for providing a review to a user system from a CRM system. In this case, the method 100 can be implemented in the context of the CRM server 220 hosting the review recommendation service 310, but can also be implemented in any desired environment. With reference to FIG. 1, the method 100 begins, in block 102, by receiving a message from a requesting user system associated with a first user. In an embodiment, the message includes a request for a review relevant to a viewer affiliated with an enterprise. The message also includes information identifying a review subject and readily available information related to the viewer. The review recommendation service 310 includes a review handler component 314 configured to receive the message from the requesting user system 400 associated with the first user 203.

According to an embodiment, the information identifying the review subject 471 can include a product name, a brand, information identifying an industry, and/or information identifying a competitor enterprise. The readily available information related to the viewer 481 is information that the first user 203 can obtain through conventional means, e.g., a general Internet search or a directory search, and without necessarily interviewing the viewer 201. For example, the readily available information related to the viewer 481 can include information identifying the viewer 201, i.e., the viewer's name, and an enterprise affiliated with the viewer 201 and is not highly personal information about the viewer 201. The information identifying the review subject 471 and/or the readily available information related to the viewer 481 can be stored on the requesting user system 400, e.g., as configuration data or a default setting. Alternatively or in addition, the information 471, 481 can be provided by the first user 203 via an input form or some other input document.

According to an embodiment, the viewer 201 can be a third party user and the first user 203 can be a user who is identifying reviews for the viewer's use. In another embodiment, the viewer 201 can be the first user 203, and is identifying reviews for his or her own use. When the viewer 201 is the first user 203 associated with the requesting user system 202, the message can also include real-time user-specific information 491 associated with the viewer 201/user 203 and collected by and stored on the requesting user system 202.

In an embodiment, the real-time user-specific information 491 can comprise information collected and/or used by various client applications hosted by the requesting user system 400 and stored locally on the requesting user system 400. For example, real-time user-specific information 491 can include interaction information gathered from an email client, a telephone application, a social networking application, a web browser, and/or any number of messaging applications that allow the user 203 to interact with his contacts 203a, 203b or other entities, e.g., the social networking service 205. Accordingly, in an embodiment, the information 491 can include contact information associated with at least some of the viewer's contacts 203a, 203b, historical information relating to the viewer's business and personal interactions with the viewer's contacts 203a, 203b, messages posted to, sent to and received from the viewer's contacts 203a, 203b; telephone calls made to and received from the viewer's contacts 203a, 203b; and notifications associated with the viewer's contacts 203a, 203b received from one or more social networking services 205. In addition, the information 491 can also include information relating to the user's web browsing history, searches and/or downloads.

In addition or alternatively, the real-time user-specific information 491 can also include, in an embodiment, geo-location information associated with the requesting user system 400 gathered from a Global Positioning System (“GPS”) unit in the requesting user system 400. For example, the requesting user system 400 can be a handheld mobile device that includes a GPS unit that is configured to calculate the requesting user system's 400 location based on received satellite signals. The geo-location information can include, in an embodiment, latitude and longitude information associated with a location at a particular time. The geo-location information can also include correlated information related to the latitude and longitude information. For example, the correlated information can comprise an address, a business name and/or contact name associated with the address, and an identifier identifying the location. In an embodiment, the GPS unit in the requesting user system 400 can track and record the system's location periodically, e.g., every 10 minutes, and the geo-location information can include the current location of the system 400 when the message is sent, and previous recorded location(s) of the requesting user system 400.

According to an embodiment, the review handler component 312 in the review recommendation service 310 is configured to receive the message from the requesting user system 400 over the network 230 via a network subsystem 302 and an application protocol layer, or other higher protocol layer, as illustrated by an exemplary HTTP protocol layer 303, among many possible standard and proprietary protocol layers. These higher protocol layers can encode, package, and/or reformat data for sending and receiving messages over a network layer, such as Internet Protocol (IP), and/or a transport layer, such as Transmission Control Protocol (TCP) and/or User Datagram Protocol (UDP). A request handler component 306 in the CRM system 300 can be configured to receive the message via the incoming data handler 304 and to route the message to the CRM recommendation service 310 for further processing.

Referring again to FIG. 1, when the message including the request for recommended information is received, a plurality of reviews 320 related to the review subject is identified in block 104. According to an embodiment, each review 320 is provided by a reviewer, and each is managed by the CRM system 300. In an embodiment, the review handler component 312 in the review recommendation service 310 is configured to identify the plurality of reviews 320 related to the review subject.

In an embodiment, when the message from the requesting user system 400 is received, the review handler component 312 can be configured to extract the information identifying the review subject 471 from the message and to generate at least one search query for reviews 320 relating to the review subject. In an embodiment, the review handler component 312 can include a query manager 313 configured to generate and to submit the one or more search queries to the data manager component 308 in the CRM system 300, which can be configured to retrieve and return reviews 320a satisfying the one or more search queries.

For example, when the information identifying the review subject 471 includes information identifying a product, the query manager 313 can be configured to generate a search query based on the product name, and to submit the query to the data manager component 308. In response, the data manager component 308 can retrieve from the data store 321 and return to the record handler component 312 a review 320a satisfying the query.

In an embodiment, when the reviews 320a related to the review subject are received, the review handler component 312 can be configured to determine which of the reviews 320a the viewer 201 is authorized to access. For instance, in an embodiment, the review handler component 312 can apply an access control policy 314 that defines a viewer's access rights to each review 320a based on several control factors, such as review subject type, security level associated with the review 320a, the viewer's title, role, and/or enterprise, and/or any other control factor. In an embodiment, when the review handler component 312 determines that the viewer 201 is unauthorized to access a review 320a, that review 320a is filtered out, i.e., eliminated from consideration, and can be discarded or returned to the data manager component 308.

According to an embodiment, when the review handler component 312 determines that the viewer 201 is authorized to access the review 320a, the review handler component 312 can be configured to determine, for each of the reviews 320a, an identifier 331 identifying the review 320a. For example, the CRM system 300 typically provides and stores an identifier 331 for and with each data object, and the review handler component 312 can be configured to detect the identifier 331 from the review 320a. In another embodiment, the review handler component 312 can be configured to generate an identifier 331 and to associate the identifier 331 with the review 320a.

Referring again to FIG. 1, once the plurality of reviews 320a related to the review subject has been identified, a relevance score for each of the plurality of records 320a is determined based on a plurality of relevance factors and a plurality of social media influence factors in block 106. According to an embodiment, a relevancy score handler component 316 in the review recommendation service 310 can be configured to determine the relevance score for each of the plurality of reviews 320a, wherein the relevance score is based on a plurality of relevance factors 317 relating to the viewer and to data objects managed by the CRM system 300 and on a plurality of social media influence factors 317a relating to social media content from at least one social networking entity 205.

According to an embodiment, the relevance factors 317 and the social media influence factors (“influence factors”) 317a can be used to determine how, whether and to what extent a particular review 320a is likely to be relevant to the viewer 201. For example, when the review 320a under consideration is provided by a reviewer 321, a relevance factor 317 can be directed to a type of a relationship between the viewer 201 and the reviewer 321, e.g., whether the viewer 201 and the reviewer 321 are friends, siblings, former coworkers, business acquaintances and/or college roommates. In another embodiment, a relevance factor 317 can be directed to a frequency with which the viewer 201 has interactions with the reviewer 321, i.e., how many times has the viewer 201 called, emailed, and/or texted the reviewer 321. In addition, a relevance factor 317 can be directed to a number of common attributes between the viewer 201 and the reviewer 321, e.g., whether the viewer 201 and the reviewer 321 are from the same city, are parents, are runners, and/or are college educated.

Alternatively or in addition, a relevance factor 317 can be directed to a type of a relationship between the enterprise affiliated with the viewer 201 and an enterprise affiliated with the reviewer 321, a frequency with which the viewer's enterprise has interactions with the reviewer's enterprise, and to shared attributes of the enterprises. Another relevance factor 317 can be directed to a temporal proximity of a creation of the review 320, i.e., how recent the review 320 is. In an embodiment where real-time user-specific information 491 and geo-location information associated with the viewer 201 are provided, relevance factors 317 can be directed to how many contacts the viewer 201 and reviewer 321 have in common, and a location proximity of the reviewer 321 and/or the reviewer's enterprise to the location of the viewer 201. Other relevance factors 317 can be defined and directed to a variety of subjects.

According to an embodiment, the relevance score for each of the accessible records 315 is also based on a plurality of influence factors 317a, which can be used to determine how, whether and to what extent a particular review 320a is likely to be relevant to the viewer 201 based on social media activity associated with the viewer 201, the reviewer 321 and/or the review 320a. In an embodiment, influence factors 317a based on social media activity associated with the review 320a can be directed to the number of times the review 320a was accessed, e.g., selected, read, listened to and/or watched, a status/attribute of an entity that accessed the review 320a, a number of reactions and comments relating to the review 320a, and/or a sentiment of reactions and comments relating to the review 320. For example, the review 320a can be considered relevant to the viewer 201 when the review 320a generates numerous comments and/or when numerous users indicate that they agree with, or have an affinity toward, the posted review 320a. In an embodiment, such a reaction can be submitted when a user “likes” the review 320a and/or “likes” a comment relating to the review 320a.

In another embodiment, an influence factor 317a can be based on the social media activity of the reviewer 321 and can be directed to the reviewer's influence. Thus, for example, an influence factor 317a can be directed to a number of users following the reviewer 321, and/or a social and/or professional status or attribute of the reviewer 321 and/or a following user. For example, when a following user's professional status or attribute indicates that she is the chief executive officer (CEO) of an enterprise, this fact can be an indication that the reviewer 321 is highly influential because the CEO is presumably interested in viewing the reviewer's 321 posts. Another influence factor 317a can be directed to a number and/or a social and/or professional status/attribute of second degree users following the following user, and whether the review 320a posted by the reviewer 321 is reposted by the following users to their respective following users. For example, when a following user is a film celebrity who is followed by millions of fans, a movie review 321 posted by the reviewer 321 can potentially reach the millions of fans when the celebrity following the reviewer 321 reposts the review 320a. Other influence factors 317a can be defined and directed to a variety of subjects.

In an embodiment, each relevance factor 317 and/or influence factor 317a can be weighted by a weighting factor to reflect its importance relative to the other relevance 317 and/or influence 317a factors. For example, a relevance factor 317 directed to a trusted relationship between the viewer 201 and the reviewer 321 can be weighted heavier than a relevance factor 317 directed to how many emails the viewer 201 sent to/received from the reviewer 321 based on a presumption that a trusted relationship is more important to the viewer 201 than the number of emails to/from the reviewer 321. In another example, an influence factor 317a directed to the sentiment of reactions and comments relating to the review 320a can be weighted heavier than an influence factor 317a directed to the number of reactions and comments relating to the review 320a on a presumption that the sentiment of the comments are more important to the viewer 201 than merely the number of comments.

The weighting factor of a relevance 317 and/or influence 317a factor can be at least equal to one (1) and can be determined by an administrator or by default in an embodiment. Alternatively or in addition, the viewer 201 and/or first user 203 can provide the weighting factor of the relevance 317 and/or influence 317a factor to reflect the viewer's/first user's personal preferences.

In an embodiment, the relevancy score handler 316 can be configured to identify, for a type of review 320a, a subset of relevance factors 317 of the plurality of relevance factors 317 and a subset of influence factors 317a of the plurality of influence factors 317a. For example, a type of review can be reviews 320a provided by reviewers 321 who share certain attributes with the viewer 201, e.g., the reviewers 321 and the viewer 201 are software developers. For such a review type, a subset of relevance factors 317 can include a relevance factor 317 directed to a type of a relationship between the viewer 201 and the reviewer 321; while, a relevance factor 317 directed to the reviewer's enterprise can be excluded from the subset. Another review type can be reviews 320a provided by reviewers 321 who are affiliated with particular enterprises that share certain attributes with the viewer's enterprise, e.g., the reviewer's enterprise is in the same industry as the viewer's enterprise. In this case, a subset of relevance factors 317 can include a relevance factor 317 directed to a frequency with which the viewer's enterprise has interactions with the reviewer's enterprise. When the subset is identified, the relevancy score handler 316 can be configured to disregard relevance 317 and/or influence 317a factors excluded from the subset, and to determine a raw score for the each of the relevance 317 and/or influence 317a factors in the subset.

Alternatively or in addition, the relevancy score handler 316 can be configured to identify another subset of relevance 317 and/or influence 317a factors based on a relevance type, such as socio-relevance and/or geo-relevance. As discussed above, relevance 317 and/or influence 317a factors can be used, in an embodiment, to determine how a review 320a is relevant to the viewer 201. Accordingly, a first subset of relevance 317 and/or influence 317a factors directed to the geo-location of the user system 400 and/or of a review 320a can be considered to determine a first raw score for the each of the relevance 317 and/or influence 317a factors in the first subset, and a second subset of relevance 317 and/or influence 317a factors directed to the viewer's interactions can be considered to determine a second raw score for each of the factors 317, 317a in the second subset. In an embodiment, the first raw scores can be used to determine the geo-relevance of the review 320a to the viewer 201, and the second raw scores can be used to determine the socio-relevance of the review 320a to the viewer 201.

According to an embodiment, the relevancy score handler component 316 can be configured to analyze each record 320a in light of the plurality of relevance 317 and the plurality of influence 317a factors in order to determine a raw score for each relevance 317 and influence 317a factor. In an embodiment, each raw score can be derived at least in part from the information related to the viewer 481, real-time user-specific information 491, information managed by the CRM system 300, and/or information received from social networking entities 205.

In an embodiment, for example, the relevancy score handler component 316 can invoke the query manager 313 to generate a query for data objects managed by the CRM system 300 (e.g., contact records 322, event records 324, and account records 325) relating to the viewer 201, the reviewer 321 and/or the review 320a. The relevancy score handler component 316 can use that information to determine the raw scores for at least some of the relevance factors 317. In addition, the relevancy score handler component 316 can invoke a social media handler component 312a in the record recommendation service 310 to retrieve public real-time social media content 210 relating to the viewer 201, the review 320a, and/or the reviewer 321 from the social networking entities 205. In an embodiment, social media content 210 can include social networking data 207 and social media objects 206. The social networking data 207a can include, but is not limited to, professional and personal information identifying and pertaining to the viewer 201 and/or the reviewer 321, information identifying entities following the viewer 201 and/or the reviewer 321, and entities followed by the viewer 201 and/or the reviewer 321. Social media objects 206 can include text objects, and video, audio and image objects, and reactions and comments relating to such posted objects. In addition, the social networking data 207a can include a number of times the review 320a was accessed, information identifying at least one entity, e.g., a user or an enterprise, that has accessed the review 320a, and/or reactions and comments relating to the review 320a. In an embodiment, the relevancy score handler component 316 can receive the social media information and can analyze this data in light of at least one of the plurality of social media influence factors 317a.

In an embodiment, a relevance 317 or an influence 317a factor can be treated as a question, and a raw score for the factor 317, 317a can be determined based on an answer to the question. For instance, a relevance factor 317 that is directed to a type of relationship between the viewer 201 and the reviewer 321 can be treated as the question, “How is the viewer 201 related to the reviewer 321?” The relevancy score handler component 316 can be configured to answer this question based at least in part on the data managed by the CRM system 300 relating to the viewer 201 and the reviewer 321 that indicates whether and how the reviewer 321 is related to the viewer 201. In addition, an influence factor 317a that is directed to a status/attribute of an entity that accessed the review 320 can be treated as the question, “Is the entity an important person or enterprise?” The relevancy score handler component 316 can be configured to answer this question based at least in part on the social networking data 207 related to the entity that indicates the person's job title or whether the enterprise is large.

In an embodiment, the raw score for a factor 317, 317a can be a value between a minimum value, e.g., zero (0), and a maximum value, e.g., ten (10). The minimum value can indicate a low level of relevancy and the maximum value can indicate a high level of relevancy between the viewer 201 and the review 320a according to this particular relevance 317 and/or influence 317a factor. For example, when the number of interactions between the viewer 201 and the reviewer 321 during the preceding seven (7) days is zero, the determined raw score for a relevance factor directed to the frequency with which the viewer 201 interacts with the reviewer 321 can be the minimum value, indicating that the reviewer 321 is not important to the viewer 201 based on this relevance factor 317. Alternatively, when the number of interactions is high, e.g., above a threshold set by an administrator or by default, the determined raw score can be the maximum value, indicating that the reviewer 321 is important to the viewer 201 based on this relevance factor 317. In an embodiment when the relevance 317 and/or influence 317a factor is weighted by a weighting factor, the determined raw score can be multiplied by the weighting factor to generate a weighted raw score for the relevance 317 and/or influence 317a factor.

According to an embodiment, once the raw score and/or the weighted raw score for each relevance 317 and/or influence 317a factor considered is determined, the relevancy score handler 316 can be configured to determine the relevance score 332 for the review 320a by accumulating the raw and/or weighted raw scores to generate a sum of the raw and/or weighted raw scores. In an embodiment, the sum of the raw and/or weighted raw scores is the relevance score 332 for the review 320a and indicates the relevance of the record 320a to the viewer 201.

According to an embodiment, the relevancy score handler 316 can be configured to determine more than one relevance score 332 for the review 320. For example, in an embodiment, an overall relevance score 332 can be determined based on the sum of the raw and/or weighted raw scores for each of the plurality of relevance 317 and/or influence 317a factors. Alternatively or in addition, a specialized relevance score 332a can be determined based on the sum of the raw scores for a subset of factors 317, 317a. For example, as described above, a first subset of factors 317, 317a can be directed to the geo-location of the user system 400 and/or of a review 320a. In this case, a geo-relevance score 332a can be determined based on the sum of the raw and/or weighted scores for the factors 317, 317a in the first subset. Alternatively, a second subset of relevance 317 and/or influence 317a factors can be directed to the viewer's interactions, and a socio-relevance score 332b can be determined based on the sum of the raw and/or weighted raw scores for the relevance 317 and/or influence 317a factors in the second subset. In an embodiment, the geo-relevance score 332a and the socio-relevance score 332b indicate the geo-relevance and the socio-relevance, respectively, of the review 320a to the viewer 201.

Referring again to FIG. 1, once the relevance scores 332 for each of the reviews 320a is determined, at least one recommended review is selected from the plurality of reviews 320a, in block 108, based on the relevance score 332 of the at least one recommended review(s). According to an embodiment, the relevancy score handler component 316 in the review recommendation service 310 can be configured to select at least one recommended review 320b from the plurality of reviews 320a based on the relevance score 332 of the at least one recommended review 320b.

According to an embodiment, the relevancy score handler component 316 can be configured, in an embodiment, to select a recommended review 320b by identifying a review having a relevance score 332 greater than a predetermined relevancy threshold value. The relevancy threshold value can be a default value set by an administrator in an embodiment. Alternatively or in addition, the relevancy threshold value can be a value defined by the viewer 201 and/or the first user 203. In an embodiment, more than one relevancy threshold value can be applied. For example, the relevancy score handler component 316 can be configured to apply the default threshold value on a first pass over the reviews 320a relating to the review subject, and depending on how many reviews have scores that exceed the default threshold value, can apply the viewer/first user defined threshold value to filter reviews from or add reviews to the group of recommended reviews 320b. Alternatively or in addition, a first relevancy threshold value can be applied for a first type of review 320a, e.g., based on a relationship between the viewer 201 and the reviewer 321, and a second threshold value can be applied for a second type of review 320a, e.g., based on a relationship between the viewer's enterprise and the reviewer's enterprise. In an embodiment, the first and second threshold values can be the same, or in another embodiment, they can be different.

In another embodiment, the relevancy score handler component 316 can be configured to select at least one recommended review 320b from the reviews related to the review subject 320a by generating a sorted list comprising the reviews 320a sorted by their respective relevance scores 332. In an embodiment, the reviews related to the review subject 320a can be sorted in an order from highest score 332 to lowest score 332, i.e., most relevant to least relevant. Once the sorted list is generated, the relevancy score handler component 316 can be configured to select a predetermined number of reviews 320a from the sorted list, e.g., the top five (5) records, to be the at least one recommended review(s) 320b. In an embodiment, the predetermined number can be a default value set by the administrator or a value defined by the viewer 201 and/or the first user 203.

In another embodiment, the relevancy score handler component 316 can be configured to select at least one recommended review 320b from the related reviews 320a based on both the predetermined number and the relevancy threshold value. For example, the relevancy score handler component 316 can generate the list of reviews 320a sorted by relevance score 332 and can identify the top ten (10) reviews 320a from the list. The relevancy score handler component 316 can then select the recommended reviews 320b by selecting from the identified top ten (10) reviews 320a recommended reviews 320b that have relevance scores 332 exceeding the relevance threshold value(s).

According to an embodiment, the relevancy score handler component 316 can also generate a list of records 320a sorted by their geo-relevance score 332a and/or a list of records 320a sorted by their socio-relevance score 332b. From either or both of these lists, the relevancy score handler component 316 can select recommended reviews 320b based on their geo-relevance or socio-relevance to the viewer 201, as well as based on their overall relevance to the viewer 201. Alternatively or in addition, the relevancy score handler component 316 can generate a list of reviews 320a sorted by their record type scores 332, and recommended reviews 320b of a particular type can be selected. For example, the reviews 320a can be sorted by record type scores 332 into lists of record types, and the relevancy score handler component 316 can select recommended reviews 320b from each list based on their relevance scores 332.

Referring again to FIG. 1, in block 110, once the at least one recommended review 320b is selected, a response message including information identifying the at least one recommended review 320b is transmitted to the requesting user system 400 associated with the first user 203. According to an embodiment, a list handler component 319 in the review recommendation service 310 is configured to transmit a response message 334 including information identifying the at least one recommended review 320b to the requesting user system 400.

As stated above, in an embodiment, each of the reviews related to the review subject 320a is associated with an identifier 331 and when a recommended review 320b is selected, the list handler component 319 can be configured to determine the identifier 331 identifying the recommended review 320b. For example, the identifier 331 can be extracted from the recommended review 320b when it is selected from the related reviews 320a. According to an embodiment, the list handler component 319 can be configured to generate a ranked list 335 comprising the identifiers 331 identifying the recommended reviews 320b. In an embodiment, the ranked list 335 can rank the identifiers 331 by the relevancy scores 332 of the recommended reviews 320b in an order from highest score 332 to lowest score 332, i.e., most relevant to least relevant. Additionally, the ranked list 335 can include the relevance scores 332 along with the associated identifiers 331 identifying the recommended reviews 320b.

As described above, the recommended reviews 320b can be selected based on their particular record type and/or particular relevancy, e.g., geo-relevance or socio-relevance, to the viewer 201. In an embodiment, the list handler component 319 can be configured to generate at least one specialized ranked list 335 based on a record type and/or a relevance type. For example, the list handler component 319 can be configured to generate a first list 335a corresponding to a geo-relevance ranked list and/or a second list 335b corresponding to a socio-relevance ranked list comprising identifiers 331 identifying the geo-relevant and/or socio-relevant recommended reviews 320b, respectively. Alternatively or in addition, a ranked list 335 corresponding to a particular record type can be generated that comprises information identifying the recommended reviews 320b of that particular record type that are relevant to the viewer 201. For example, a first ranked list 335a can be generated for recommended reviews 320b where the reviewer 321 has a strong relationship with the viewer 201 and a second ranked list 335b can be generated for recommended reviews 320b where the reviewer's enterprise is important to the viewer 201 and/or the viewer's enterprise. The first ranked list 335 can include information identifying at least one reviewer 321 and the second ranked list 335 can include information identifying at least one enterprise related to the viewer 201 and/or the viewer's enterprise.

The list handler component 319 can be configured, in an embodiment, to build the response message 334 and to include the information identifying the recommended review(s) 320b, e.g., the identifiers 331 and/or the ranked list(s) 335, and to provide the response message 334 to the outgoing data handler 309 in the CRM system 300. In an embodiment, the outgoing data handler 309 can be configured to interoperate directly with the protocol layer of the network subsystem 302 or with the application protocol layer 303. The message 334 including the identifying information, e.g., the ranked list(s) 335, can be transmitted as a whole or in parts via the network subsystem 302 over the network 230 to the requesting user system 400 associated with the user 203.

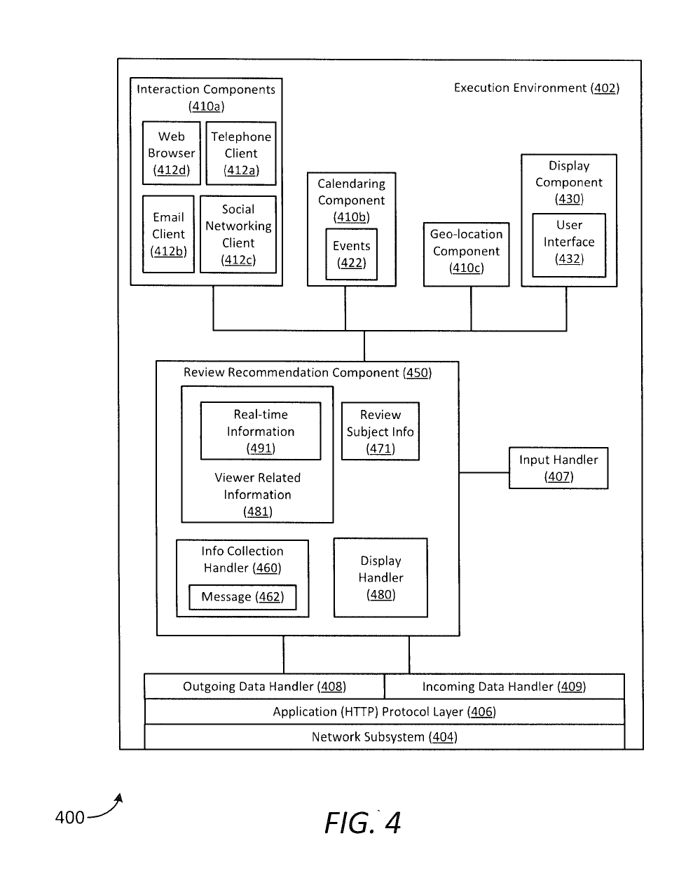

FIG. 4 is a block diagram illustrating an exemplary requesting user system 400 system configured to provide an execution environment 402 for requesting and presenting recommended reviews 320b from the CRM system 300. In an embodiment, the user system 400 can also include a display component 430 configured for displaying content to the first user 203 on a user interface 432. In addition, the user system 400 can include incoming 409 and outgoing 408 data handler components for receiving and transmitting information from and to other user system nodes 202, servers 204, and the CRM server 220 via the network 230.

In an embodiment, the user system 400 is configured to host at least one component or application that supports user-specific functions. For example, the user system 400 can include interaction components 410a that allow the first user 203 to interact or communicate over the network 230 with other users 203a, 203b and/or services, such as web services or social networking services 205. Interaction components 410a can include, but are not limited to, a telephone client application 412a, an email client application 412b, a social networking client application 412c, and a web browser application 412d. The user system 400 can also include a calendaring component 410b that allows the first user 203 to calendar events 422, e.g., meetings, tasks, deadlines, etc., and a geo-location component 410c that tracks and/or maps the user system's current and/or historical geo-location information. Other components 410 or applications 412 that support user-specific functions are available, e.g., book reading components and music components, and therefore the components 410 and applications 412 supported by the user system 400 are not limited to those illustrated and/or described above.

According to an embodiment, the execution environment 402 provided by the user system 400 includes a review recommendation component 450 that is configured to provide a review relevant to the viewer 201. The recommendation component 450 can include, in an embodiment, an information collection handler component 460 configured to receive an indication to request reviews relevant to the viewer 201. The indication can be received in a number of ways. For example, it can be received directly from the first user 203 via an input handler component 407 that interfaces with an input device (not shown) such as a keyboard or touch screen, via audio input, and/or via a scanning or imaging device.

When the indication is received, the information collection handler component 460 can be configured to collect the information identifying the review subject 471 and readily available information related to the viewer 481. As stated above, the information identifying the review subject 471 and/or the readily available information related to the viewer 481 can be stored on the user system 400, e.g., as configuration data or a default setting. Alternatively or in addition, the information 471, 481 can be provided by the first user 203 via the input handler component 407.

According to an embodiment, the first user 203 can be a salesperson preparing for a meeting with a client who is interested in purchasing a product and/or a service, and the recommended reviews relating to the product/service can be presented to the client during the meeting. In this case, the client is the viewer 201. In another embodiment, the first user 203 is the viewer 201 who is interested in accessing reviews that are meaningful. In this case, the collection handler component 460 can also be configured to collect the real-time user-specific information 491 stored on the user system 400. In this case, the information collection handler component 460 can be configured to access storage blocks associated with the components 410a-410c or applications 412a-412d supporting user-specific functions, and to collect real-time user-specific information 491 associated with the components 410a-410c or applications 412a-412d, which can then be included with the readily available information related to the viewer 481.

In an embodiment, when the information identifying the review subject 471 and the information related to the viewer 481 is collected, the information handler component 460 can be configured to build a message 462 that includes the request for the review relevant to the viewer 201 and the information identifying the review subject 471 and information related to the viewer 481. Once the message 462 is built, the information handler component 460 can provide the message 462 to the outgoing data handler 408 in the user system 400. In an embodiment, the outgoing data handler 408 can be configured to interoperate directly with a protocol layer of a network subsystem 404 or with an application protocol layer 406. The message 462 can be transmitted as a whole or in parts via the network subsystem 404 over the network 230 to the CRM server 220 hosting CRM system 300.

As described above, when the message 462 is transmitted to the CRM server 220, the review recommendation service 310 can be configured to receive the message 462 and to identify reviews related to the review subject 320a, to select recommended reviews 320b based on the relevance scores of the identified reviews 320a, and to transmit information identifying the recommended reviews 320b in a response message 334 to the user system 400. According to an embodiment, a display handler component 480 in the review recommendation component 450 can be configured to receive the response message 334 via the incoming data handler 409 in the user system 400, and can be configured to display at least a portion of the information identifying the recommended reviews 320b on a user interface 432 of the user system 400. In an embodiment, the display handler component 480 can provide the information to the display component 430, which can be configured to render the information for display on the user interface 432.

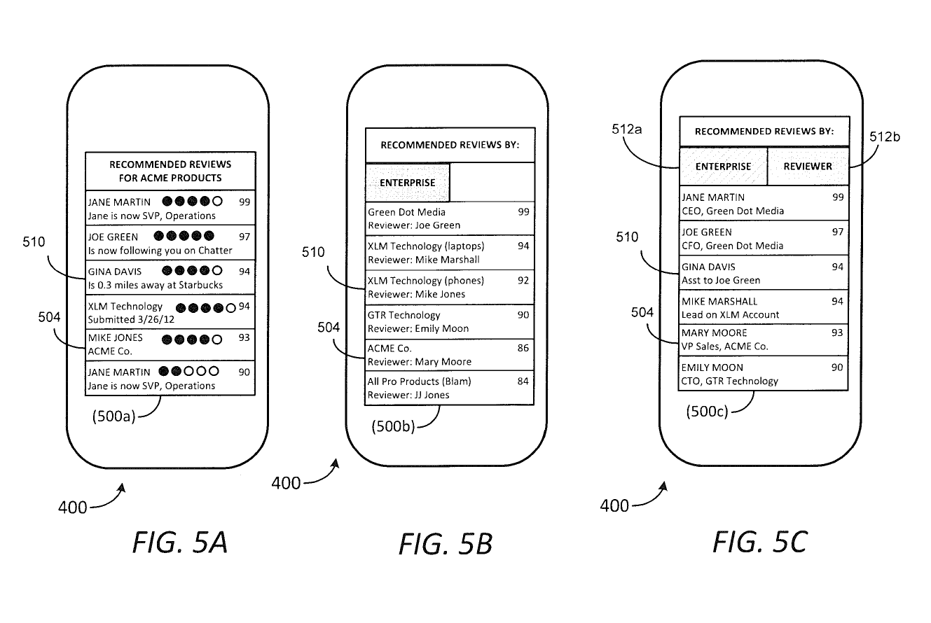

According to an embodiment, the display component 430 can be configured to render the information in a number of formats suiting the information. For example, in FIG. 5A, the display component 430 can present on the user interface 432 a list 500a that includes entries 510 for the information identifying the recommended reviews 320b. According to an embodiment, each entry 510 can represent each recommended review 320b and can include the reviewer's name and contextual information 504 about the review 320b and/or the reviewer 321. For example, when the reviewer a person named “Jane Martin,” the contextual information 504 can indicate the person's title and company, and when another reviewer, e.g., “Gina Davis,” is nearby, the contextual information 504 can indicate where the reviewer is so that the viewer 201 can when meet the reviewer.

In another embodiment, illustrated in FIG. 5B and FIG. 5C, the display component 430 can present on the user interface 432 a list 500b, 500c that includes entries 510 for the information identifying the recommended reviews 320b of a particular review type, e.g., those related to an enterprise 500b or those related to a reviewer 500c. In FIG. 5B and FIG. 5C, recommended reviews 320b corresponding to enterprises and reviewers, respectively, that are relevant to the viewer 201 can be listed in an order based on each review's relevance score 332. According to an embodiment, the first user 203 can toggle between the enterprise list 500b shown in FIG. 5B and the reviewer list 500c shown in FIG. 5C. For example, the user interface 432 can display an enterprise button 512a, which when selected presents the enterprise list 500b, and a reviewers button 512b, which when selected presents the reviewer list 500c.

According to aspects of the exemplary embodiments, reviews relevant to a viewer can be provided with little or no input from the viewer 201 and/or the first user 203. In an embodiment, readily available information about the viewer 201 can be used by the review recommendation service 310 to identify personal information about the viewer 201 contained in CRM data objects and social media content related to the viewer, the reviewer, the viewer's enterprise and/or the reviewer's enterprise. This personal information is then used to select the recommended reviews 320b. Once selected, the recommended reviews 320b are transmitted to the user system 400 associated with the first user 203 and/or the viewer 201.

### System Overview

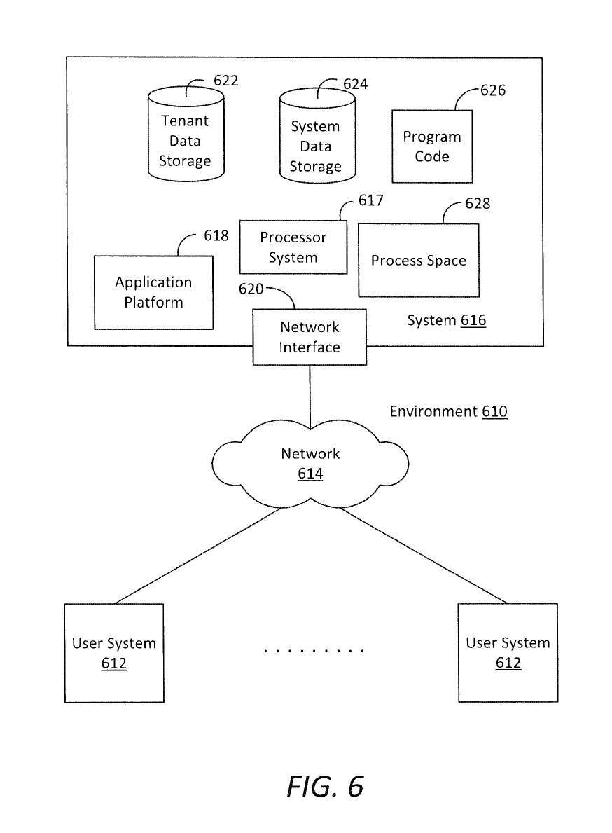

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

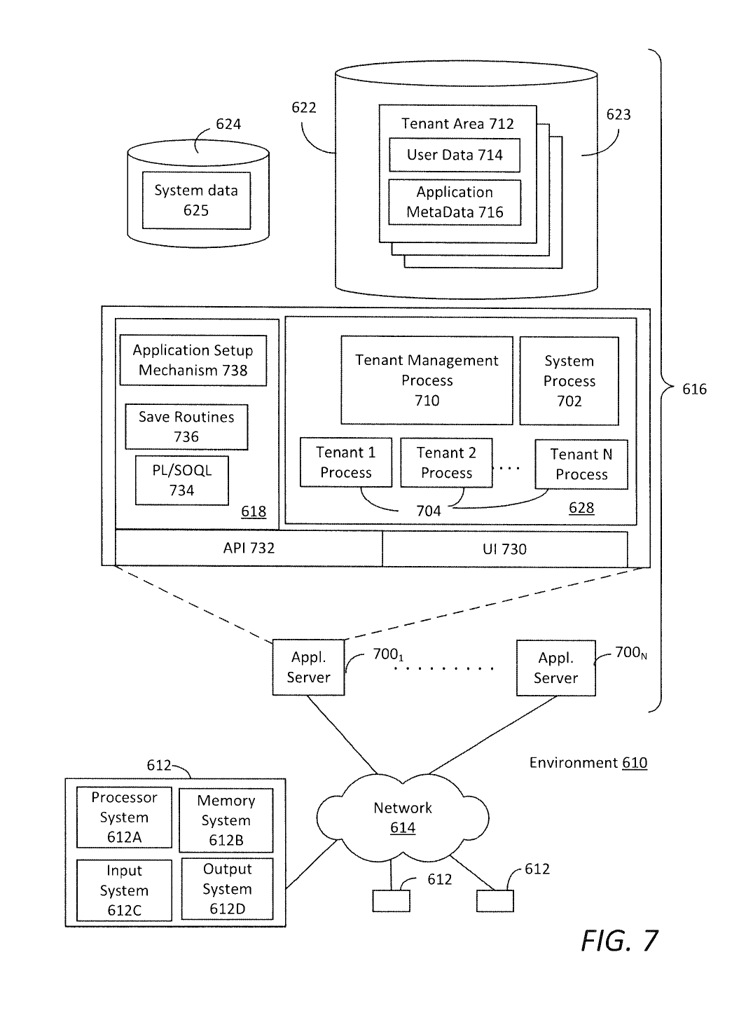

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Pentium® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user data storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700₁-700_{N}, an application platform 618, tenant data storage 622, and system data storage 624. Also shown is system process space 702, including individual tenant process spaces 704 and a tenant management process space 710. Each application server 700₁-700_{N} may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user data storage 71.4 and application metadata 716 might be similarly allocated for each user. For example, a copy of a user's most recently used (MRU) items might be stored to user data storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data 623 and the system data 625 may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is hereby incorporated by reference in its entirety and for all purposes. Invocations to applications may be detected by one or more system processes, which manages retrieving application metadata 716 for the subscriber making the invocation and executing the metadata as an application in a virtual machine.

Each application server 700₁-700_{N} may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700₁-700_{N} and the database system. However, it will be apparent to one skilled in the art that other transport protocols may be used to optimize the system depending on the network interconnect used.

In certain embodiments, each application server 700₁-700_{N} is configured to handle requests for any user associated with any organization that is a tenant. Because it is desirable to be able to add and remove application servers from the server pool at any time for any reason, there is preferably no server affinity for a user and/or organization to a specific application server 700₁-700_{N}. In one embodiment, therefore, an interface system implementing a load balancing function (e.g., an F5 Big-IP load balancer) is communicably coupled between the application servers 700₁-700_{N} and the user systems 612 to distribute requests to the application servers 700₁-700_{N}. In one embodiment, the load balancer uses a least connections algorithm to route user requests to the application servers 700₁-700_{N}. Other examples of load balancing algorithms, such as round robin and observed response time, also can be used. For example, in certain embodiments, three consecutive requests from the same user could hit three different application servers 700₁-700_{N}, and three requests from different users could hit the same application server 700₁-700_{N}. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700₁-700_{N} to request and update system-level and tenant-level data from system 616 that may require sending one or more queries to tenant data storage 622 and/or system data storage 624. System 616 (e.g., an application server 700₁ in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, titled CUSTOM ENTITIES AND FIELDS IN A MULTI-TENANT DATABASE SYSTEM, by Weissman, et al., and which is hereby incorporated by reference in its entirety and for all purposes, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations and techniques have been described with reference to an embodiment in which techniques for providing machine status information in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for providing a review to a user system from a customer relationship management system, the method comprising:
receiving a message from a requesting user system associated with a first user, the message including a request for a review relevant to a viewer affiliated with an enterprise, wherein the message also includes information identifying a review subject and readily available information related to the viewer;
identifying a plurality of reviews related to the review subject wherein each review is provided by a reviewer and each review is managed by a customer relationship management (CRM) system;
determining a relevance score for each of the plurality of reviews, wherein the relevance score is based on a plurality of relevance factors relating to the viewer and to data managed by the CRM system, and on a plurality of social media influence factors relating to social media content from at least one social networking entity;
selecting at least one recommended review from the plurality of reviews based on the relevance score of the at least one recommended review; and
transmitting a response message to the requesting user system, the response message including information identifying the at least one recommended review.

2. The method of claim 1 wherein receiving the message from the requesting user system comprises receiving the message over a network, wherein the network is at least one of a public and a private network, and wherein the CRM system includes a multi-tenant on-demand database system.

3. The method of claim 1 wherein the readily available information related to the viewer includes at least one of information identifying the viewer and information identifying the viewer's enterprise, and wherein the review is related to the reviewer's opinion of the review subject.

4. The method of claim 3 wherein the plurality of relevance factors is directed to at least one of a type of relationship between the viewer and the reviewer, a frequency with which the viewer has interactions with the reviewer, a number of common attributes between the viewer and the reviewer, a type of relationship between the enterprise affiliated with the viewer and an enterprise associated with the reviewer, a frequency with which the viewer's enterprise has interactions with the reviewer's enterprise, a number of common attributes between the viewer's enterprise and the reviewer's enterprise, and a temporal proximity of a creation of the review.

5. The method of claim 1 further comprising receiving at least one of social networking data and social media objects from at least one social networking entity, the social networking data relating to at least one of the viewer, a review managed by the CRM system and a reviewer of the review, wherein the social networking data includes at least one of a number of times the review was accessed, information identifying at least one entity that has accessed the review, information identifying at least one entity followed by the viewer, and information identifying at least one entity following the reviewer, and wherein the plurality of social media influence factors is directed to at least one of the number of times the review was accessed, a status/attribute of an entity that accessed the review, a number of reactions and comments relating to the review, and a sentiment of reactions and comments relating to the review.

6. The method of claim 1 wherein the first user is the viewer and the requesting user system is associated with the viewer, and wherein the message also includes real-time user-specific information associated with the viewer and collected by and stored on the requesting user system.

7. The method of claim 6 wherein the real-time user-specific information includes interaction information comprising contact information associated with at least one of the viewer's contacts and information relating to at least one of the viewer's business and personal interactions with the viewer's contacts, wherein the viewer's interactions include at least one of messages posted to, sent to and received from the viewer's contacts; telephone calls made to and received from the viewer's contacts; and notifications associated with the viewer's contacts received from a social networking entity.

8. The method of claim 7 wherein at least one of the plurality of relevance factors is directed to at least one of a type of relationship between the viewer and the reviewer, a frequency with which the viewer has interactions with the reviewer, a number of common attributes between the viewer and the reviewer, a frequency with which the viewer's enterprise has interactions with an enterprise associated with the reviewer, a number of common attributes between the viewer's enterprise and the reviewer's enterprise, a temporal proximity of a creation of the review, and a number of common contacts between the viewer and the reviewer.

9. The method of claim 6 wherein the requesting user system is a Global Positioning System (GPS)-enabled handheld mobile device and the real-time user-specific information includes geo-location information associated with the requesting user system, and wherein determining the relevance score for a review is based on at least a geo-location of the viewer and the proximity of at least one of the reviewer and an enterprise affiliated with the reviewer.

10. The method of claim 1 wherein determining the relevance score for a review comprises:
determining for each of the plurality of relevance factors a first set of raw scores based on data managed by the CRM system;
determining for each of the plurality of social media influence factors a second set of raw scores based on social media content from at least one social networking entity, the social media content relating to at least one of the viewer, the review managed by the CRM system, and a reviewer of the review; and
accumulating the first set of raw scores of each relevance factor and the second set of raw scores of each social media influence factor to generate a sum of the raw scores, wherein the relevance score for the record is the sum of the raw scores.

11. The method of claim 1 further comprising weighting each of the plurality of relevance factors and each of the plurality of social media influence factors by a weighting factor to reflect each relevance factor's importance relative to other relevance factors and each influence factor's importance relative to other influence factors.

12. The method of claim 11, wherein the weighting factor of each of the plurality of relevance factors and each of the plurality of influence factors is determined by at least one of the first user, the viewer, and an administrator.

13. The method of claim 11 wherein determining the relevance score for a review comprises:
determining for each of the plurality of relevance factors a first raw score based on data managed by the CRM system;
multiplying the first raw score by the weighting factor of the relevance factor to generate a first weighted raw score;
determining for each of the plurality of social media influence factors a second raw score based on social media content from at least one social networking entity, the social media content relating to at least one of the viewer, the review managed by the CRM system, and a reviewer of the review;
multiplying the second raw score by the weighting factor of the influence factor to generate a second weighted raw score; and
accumulating the first and second weighted raw scores to generate a sum of the weighted raw scores, wherein the relevance score for the accessible record is the sum of the weighted raw scores.

14. The method of claim 1 further comprising:
generating a ranked list comprising information identifying the at least one recommended review, wherein ranking of the identifying information is based on the relevance score of the at least one recommended review; and
including the ranked list in the response message transmitted to the requesting user system.

15. The method of claim 1 wherein a first review is of a first review type and a second review is of a second review type and wherein determining the relevance score for the first review and the second review comprises:
identifying, for the first review type, a first subset of relevance factors of the plurality of relevance factors and a first subset of social media influence factors of the plurality of social media influence factors;
identifying, for the second review type, a second subset of relevance factors of the plurality of relevance factors and a second subset of social media influence factors of the plurality of social media influence factors;
determining a first raw score for each of the relevance factors in the first subset of relevance factors and for each of the social media influence factors in the first subset of social media influence factors for the first review;
determining a second raw score for each of the relevance factors in the second subset of relevance factors and for each of the social media influence factors in the second subset of social media influence factors for the second review;
accumulating the first raw scores to generate a first sum of the raw scores, wherein the relevance score for the first review is the first sum of the raw scores; and
accumulating the second raw scores to generate a second sum of the raw scores, wherein the relevance score for the second review is the second sum of the raw scores.

16. The method of claim 15 wherein when the first and second reviews are selected as recommended records, the method further comprises:
generating, by the server, a first ranked list corresponding to the first review type and comprising information identifying at least one recommended review of the first review type including the first review, wherein ranking of the identifying information is based on the relevance score of the at least one recommended review of the first review type;
generating, by the server, a second ranked list corresponding to the second review type and comprising information identifying at least one recommended review of the second review type including the second review; and
including the first ranked list corresponding to the first review type and the second ranked list corresponding to the second review type in the response message transmitted to the requesting user system.

17. The method of 16 wherein when the first review type is based on a reviewer and the second review type is based on an enterprise affiliated with the reviewer, the first ranked list comprises information identifying at least one reviewer, and the second ranked list comprises information identifying at least one enterprise related to at least one of the viewer and the viewer's enterprise.

18. The method of claim 1 wherein selecting a recommended review from the plurality of reviews includes identifying a review having a relevance score that exceeds a predetermined relevancy threshold value, wherein the relevancy threshold is at least one of a default value and a value defined by at least one of an administrator of the CRM system, the viewer, and the first user.

19. A computer program product comprising a non-transitory machine-readable medium carrying one or more sequences of instructions for providing a review to a user system from a customer relationship management system, which instructions, when executed by one or more processors, cause the one or more processors to carry out the steps of:
receiving a message from a requesting user system associated with a first user, the message including a request for a review relevant to a viewer affiliated with an enterprise, wherein the message also includes information identifying a review subject and readily available information related to the viewer;
identifying a plurality of reviews related to the review subject wherein each review is provided by a reviewer and each review is managed by a customer relationship management (CRM) system;
determining a relevance score for each of the plurality of reviews, wherein the relevance score is based on a plurality of relevance factors relating to the viewer and to data managed by the CRM system, and on a plurality of social media influence factors relating to social media content from at least one social networking entity;
selecting at least one recommended review from the plurality of reviews based on the relevance score of the at least one recommended review; and
transmitting a response message to the requesting user system, the response message including information identifying the at least one recommended review.

20. An apparatus for providing a review to a user system from a customer relationship management system, the apparatus comprising:
a processor; and
one or more stored sequences of instructions which, when executed by the processor, cause the processor to carry out the steps of:
receiving a message from a requesting user system associated with a first user, the message including a request for a review relevant to a viewer affiliated with an enterprise, wherein the message also includes information identifying a review subject and readily available information related to the viewer;
identifying a plurality of reviews related to the review subject wherein each review is provided by a reviewer and each review is managed by a customer relationship management (CRM) system;
determining a relevance score for each of the plurality of reviews, wherein the relevance score is based on a plurality of relevance factors relating to the viewer and to data managed by the CRM system, and on a plurality of social media influence factors relating to social media content from at least one social networking entity;
selecting at least one recommended review from the plurality of reviews based on the relevance score of the at least one recommended review; and
transmitting a response message to the requesting user system, the response message including information identifying the at least one recommended review.
